(19) United States
(12) Patent Application Publication
(10) Pub. No.: US 2003/0189270 A1
(43) Pub. Date: Oct. 9, 2003

(54) Method for producing synthetic threads from polymer mixtures

(76) Inventors: Dietmar Wandel, Hanau (DE); Alexander Klein, Ingelheim (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/415,754

(22) PCT Filed: Nov. 5, 2001
(86) PCT No.: PCT/EP01/12793

(30) Foreign Application Priority Data
Nov. 4, 2000 (DE) 100 54 758.3

(51) Int. Cl. B29C 47/60

(52) U.S. Cl. 264/211.22

(57) ABSTRACT

The synthetic threads are produced from a polymer mixture consisting of polyamide as base polymer and at least one additive polymer, the polymer mixture being pressed through nozzle openings as polymer melt with extrusion speeds (s) in the range from 18 to 160 m/min. The filaments thus formed are cooled, combined to threads, drawn off and spooled by forming at least one thread spool. The content of additive polymer in the polymer mixture is not less than M wt-% and not more than 2.5 wt-%, where M is derived from 0.0001·v−0.4, where v is the draw-off speed of the thread, and v lies in the range from 4500 to 8000 m/min. The additive polymer is amorphous and virtually insoluble in the polymer melt. In the spooled thread, the additive polymer is present in the base polymer in a fibril structure, the ratio s:v lies in the range from 1:50 to 1:250. Upon spooling, the thread spool preferably has a weight of the spooled thread of at least 4 kg.

This invention relates to a process of producing synthetic threads from a polymer mixture which consists of a base polymer and at least one additive polymer, wherein the polymer mixture is pressed through nozzle openings as polymer melt with extrusion speeds (s) in the range from 18 to 160 m/min and the filaments thus formed are cooled, are combined to threads, the threads are drawn off and spooled by forming at least one thread spool.

Processing polymer mixtures to produce synthetic threads is known and described e.g. in EP-A-0860524, DE-A-19747867 and DE-A-10022889. From these documents it is known that the elongation at break of the spooled thread can be changed by additive polymers. Spinning, drawing off, optionally drafting and spooling a polyamide thread involves the problem that the microscopic structure of the thread is changed upon spooling. At high spooling speeds the thread tends to shrink on the spool, i.e. to be shortened. This results in a destruction of the thread spool, so that processing is not possible.

Without an additional thermal treatment, e.g. polyamide-6 threads can typically only be spooled with speeds between 4000 and 5200 m/min and elongations at break below 70% to obtain stable thread spools with a good spool build-up. Spooling polyamide threads with speeds >5000 m/min requires additional equipment and measures for introducing heat, in order to obtain a good and stable spool build-up.

It is the object underlying the invention to perform the above-mentioned process such that the relaxation processes in the interior of the thread are influenced favorably, so that the threads exhibit a good spooling behavior. At the same time, the threads produced should be useful for further processing.

In accordance with the invention, this object is solved in that the base polymer is polyamide (PA), that the content of additive polymer in the polymer mixture is not less than M wt-% and not more than 2.5 wt-%, M being derived from 10⁻⁴·v−0.4, where v is the draw-off speed of the thread, and v lies in the range from 4500 to 8000 m/min, that the additive polymer is amorphous and is virtually insoluble in the polymer melt, where the additive polymer in the spooled thread is present in the base polymer in a fibril structure, and that the ratio s:v lies in the range from 1:50 to 1:250. The draw-off speed is the peripheral speed of the first galette; when spinning without galettes, the draw-off speed is determined by the peripheral speed of the drive roller of the spooler.

The additive polymer is thermoplastically processable at the processing temperature of the base material, and its glass transition temperature is 90 to 170° C. and mostly 100 to 140° C. The glass transition temperature is determined in the known manner by differential scanning calorimetry (described e.g. in WO 99/07927). The additive polymer added is not compatible with the base polymer, i.e. it is virtually not soluble in the base polymer, so that two phases distinguishable by microscopy are formed in the solidified thread.

Preferably, the ratio of the melt viscosity of the additive polymer to the melt viscosity of the base polymer is 1.2:1 to 12:1. The melt viscosity is measured in the known manner by means of an oscillation rheometer at an oscillation frequency of 2.4 Hz and a temperature which is equal to the melting temperature of the base polymer plus 48° C. Details can be found in WO 99/07927. The melt viscosity of the additive polymer always is higher than that of the base polymer.

Preferably, the ratio of the melt viscosities of additive polymer and base polymer lies in the range from 2:1 to 9:1. There is produced a narrow particle size distribution of the inclusions of the additive polymer in the mixture directly upon exit from the spinneret. The inclusions are cigar-shaped with their longitudinal axis parallel to the filament axis. Tests have revealed a mean particle diameter of the additive polymer, as measured parallel to the filament cross-section, directly upon exit from the spinneret of mostly not larger than 0.3 μm, less than 1% of the inclusions contained in the mixture having a particle diameter of more than 1.0 μm. In this case, the base polymer was polyamide-6.

Due to the high flow activation energy of the additive polymer as compared to the base polymer (PA), the viscosity ratio is still increased upon exit of the polymer mixture from the spinnerets and upon drafting, so that the cigar-shaped inclusions in the spooled thread have turned into the desired fibrils of the additive polymer. This fibril structure is suitable for absorbing part of the spinning tension and for stabilizing the thread structure, which influences the relaxation behavior as desired. It is thus achieved that the threads are spooled to obtain thread spools with a good and stable spool build-up, which spools can easily be processed. Only now is it possible to produce large thread spools with a thread weight of at least 4 kg without failure, and this is a fundamental prerequisite for a productively operating spinning plant.

In general it can be said that the amount of additive polymer to be added to the base polymer can be kept relatively low, in order to achieve good strengths and favorable processing properties of the thread. Preferably, 0.1 to 1.5 wt-% of the additive polymer are added to the base polymer. For many applications, the desired improvements in the thread are already obtained when adding less than 1 wt-% additive polymer. As additive polymer with the above-mentioned properties there may for instance be used homopolymers of the substance groups polymethyl methacrylate and the derivatives thereof as well as polystyrene and the derivatives thereof. The additive polymer may also be a polymer of a monomer unit

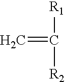

in which R₁ and R₂ are substituents consisting of the optional atoms C, H, O, S, P and halogen atoms, the sum of the molecular weights of R₁ and R₂ being at least 40.

Furthermore, the additive polymers may be copolymers and may be composed of the following monomer units:

a) styrene or C₁₋₃-alkyl-substituted styrenes,

b) acrylic acid or methacrylic acid or

c) cyclohexyl maleinimide.

d) The additive polymer may contain the following monomer units:

A=styrene or C₁₃-alkyl-substituted styrenes,

B=one or more monomers of formula I, II or III

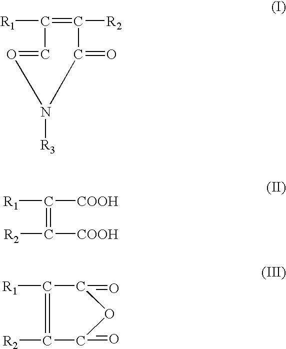

where R₁, R₂ and R₃ each is an H atom or a C₁₋₁₅ alkyl radical or a C₅₋₁₂ cycloalkyl radical or a C₆₋₁₄ aryl radical, and where the copolymer consists of 15 to 95 wt-% A and 2 to 80 wt-% B, wherein A+B=100 wt-%, preferably A=70 to 85 wt-%, B=30 to 15 wt-% and A+B=100 wt-%.

e) The additive polymer may furthermore be formed of the following monomer units:

C=acrylic acid, methacrylic acid or CH₂═CR=COOR′, where R is an H atom or a CH₃ group and R′ is a C₁₋₁₅ alkyl radical or a C₅₋₁₂ cycloalkyl radical or a C₆₋₁₄ aryl radical,

D=styrene or C₁₋₃-alkyl-substituted styrenes,

E=one or more monomers of formula I, II or III

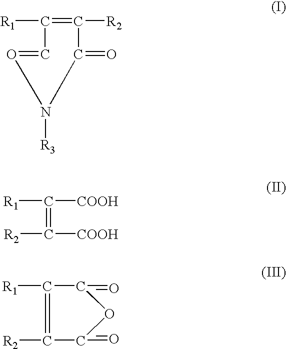

where R₁, R₂ and R₃ each is an H atom or a C₁₋₁₅ alkyl radical or a C₅₋₁₂ cycloalkyl radical or a C₆₋₁₄ aryl radical,

F=one or more ethylencially unsaturated monomers copolymerizable with C and/or with D and/or E, from the group including α-methylstyrene, vinyl acetate, acrylic esters, methacrylic esters different from C, vinyl chloride, vinylidene chloride, halogen-substituted styrenes, vinyl ethers, isopropylene ethers and dienes, the additive polymer consisting of 30 to 99 wt-% (preferably 60 to 94 wt-%) C, 0 to 50 wt-% (preferably 0 to 20 wt-%) D, >0 to 50 wt-% (preferably 6 to 30 wt-%) E and 0 to 50 wt-% (preferably 0 to 20 wt-%) F, and the sum C+D+E+F=100 wt-%.

f) The additive polymer may also be formed of the following monomer units:

G=acrylic acid, methacrylic acid or CH₂═CR—COOR′, where R is an H atom or a CH₃ group and R′ is a C₁₋₁₅ alkyl radical or a C₅₋₁₂ cycloalkyl radical or a C₆₋₁₄ aryl radical,

H=styrene or C₁₋₃-alkyl-substituted styrenes, where the polymeric additive consists of 60 to 98 wt-% G (preferably 90 to 98 wt-% G) and 2 to 40 wt-% H (preferably 10 to 20 wt-% H) (sum=100 wt-%).

As base polymers, the following should be mentioned only by way of example: polyamide-6 and polyamide-66, nylon 6, nylon 66 and the copolymers thereof. As base polymers, especially those can be used which have a melting point of 200 to 265° C. and preferably contain at least 80 wt-% of polyamide units. The relative solution viscosity for threads for textile applications expediently lies in the range from 2.2 to 3.0.

The mixture of base polymer and additive polymer to be spun may also contain additives, e.g. dyes, delustring agents, stabilizers, antistatic agents, lubricants, branching agents, UV or IR absorbers, which themselves may be polymers. Mixing the additive polymer with the base polymer may be effected in a known manner, e.g. such as described in DE-A-10022889.

For producing synthetic threads, the polymer mixture is spun by means of a usual spinning means. The molten polymer mixture is first of all pressed through the bores of a nozzle plate, and numerous filaments are produced. The diameter of the nozzle bores is chosen such that the ratio of the discharge speed of the melt mixture from the bore (extrusion speed) to the draw-off speed (v) of the thread is 1:50 to 1:250 and preferably 1:80 to 1:160.

Upon extrusion from the nozzle bores, the filaments are cooled below their solidification temperature by means of air, then bundled, provided with finish, combined to threads, drawn off and optionally interlaced.

When producing POY threads, drawing off can be effected by means of at least one driven galette or without galettes. The galettes can also be omitted when producing drafted, smooth threads (HOY), or the draft is achieved in a galette system.

In this way, a POY thread (“partly oriented yarn”) with an elongation at break of at least 50% can be produced, which is spooled without draft. The spooling speed is 1.0 to 0.95 times the draw-off speed. When producing a drafted smooth thread with an elongation at break of less than 50%, the spooling speed expediently is 1.0 to 1.5 times the draw-off speed. In both cases, the specific spooling tension is 0.04 to 0.2 g/dtex, as measured directly before the spooler.

By using the additive polymer beside the PA base polymer, it is in particular ensured that the relative increase in elongation D in the spooled thread is at least 1.02, where D=a/b with a=elongation at break of the thread consisting of the polymer mixture, and b=elongation at break of the thread which only consists of the base polymer. In the measurements, identical process conditions in particular with respect to draw-off and spooling speed and temperature should of course be maintained.

Examples 1, 2, 9 and 10 described below are comparative examples; in the other examples an inventive procedure is employed. In all examples, the same polyamide is used as base polymer.

### EXAMPLE 1

Polyamide-6 dried to about 0.07% residual moisture, with a relative viscosity (RV) of 2.44, a melting temperature of 222° C. and a melt viscosity of 80 Pas (measured at 2.4 Hz and 270° C.), was molten by means of an extruder and with a melt temperature of 270° C. supplied along a feeding and mixing means to a spinning package, which was heated to a temperature of 270° C., and extruded therefrom. The metering and mixing means as well as the spinning system are described in WO 99/07927. Viewed in melt flow direction, the spinning nozzle package included defined shearing and filtration means of the following structure: steel sand volume with a grain size of 250 to 350 μm and a height of 30 mm, cloth filter with particulate filter 20 μm, supporting plate, second cloth filter with 40 μm, spinneret plate 24 bores, bore diameter 0.25 mm, bore length 0.5 mm and a plate diameter of 65 mm.

The extruded filaments were cooled by means of conventional cross-flow quenching with an air speed of 0.35 m/s. At a distance of 1800 mm from the nozzle surface, the threads were bundled by means of an oiler and provided with an emulsion of lubricating oil and water, the applied amount of finish being about 0.4 wt-%. The thread bundle was drawn off by means of two galettes enlaced in an S-shaped manner, and by means of a spooling unit of Barmag AG, Remscheid/Germany, Type SW7, was spooled onto tubes to form thread spools. The draw-off speed, defined by the peripheral speed of the first galette, was adjusted as shown in Table 1, and the spooler speed was adjusted about 1% lower than the draw-off speed, such that the tensile force of the thread before the spooling unit was 8 g. For the different spinning speeds, the polymer throughput through the spinneret was adjusted such that the titer of the spooled thread was about 102 dtex. With the chosen nozzle bore diameter an extrusion speed of 39.6 m/min and a draft ratio s:v=1:139 is obtained. With a spooling time of only 10 min there was first of all produced a short thread spool, and the textile parameters of the spun thread were determined as indicated in Table 1.

Example 1 shows that due to the relaxation and shrink processes without addition of a suitable polymeric additive it was not possible to spool a PA6 yarn at a draw-off speed of 5500 m/min to form a thread spool over a commercially relevant period. An attempt at spooling the thread over a spooling time of 60 min to obtain a thread spool of 3.3 kg thread weight failed. It was noted that the shrink forces were so great that the thread spool could no longer be removed from the winding mandrel.

TABLE 1

| | | | Additive | Draw-off | Elongation | Breaking | Spool |
|---|---|---|---|---|---|---|---|
| | Additive | Viscosity | content | speed | at break | strength | thread |
| Example | polymer | ratio | [wt-%] | [m/min] | [%] | [cN/tex] | weight [kg] |
| 1 | — | — | 0 | 5500 | 57.7 | 44.3 | <3.3 |
| 2 | PMMA | 4.1 | 0.05 | 5500 | 58.1 | 43.9 | <3.3 |
| 3 | PMMA | 4.1 | 0.30 | 5500 | 60.2 | 43.4 | 10 |
| 4 | PMMA | 4.1 | 0.60 | 5500 | 63.6 | 43.5 | 10 |
| 5 | PS | 3.5 | 0.75 | 5500 | 60.5 | 42.1 | 10 |
| 6 | PMI | 7.5 | 0.30 | 5500 | 70.3 | 43.3 | 10 |
| 7 | PMI | 7.5 | 0.60 | 5500 | 73.5 | 43.0 | 10 |
| 8 | PMI | 7.5 | 0.60 | 6000 | 72.5 | 40.9 | 5.4 |

### EXAMPLE 2

In this comparative example, a PMMA (polymethyl methacrylate; commercial type Plexiglas 7N of Röhm GmbH, Darmstadt (Germany) was added to the base polymer from Example 1 in a concentration of 0.05 wt-%. The melt viscosity of Plexiglas 7N was 330 Pas (2.4 Hz; 270° C.), so that the ratio of additive to polyamide melt viscosity (viscosity ratio) is 4.1:1. The flow activation energy of PMMA is 140 kJ/mol, and the glass transition temperature was determined to be 111° C.

The additive polymer dried to a residual moisture of less than 0.1% was molten by means of an extruder, and by means of a gear-type metering pump was supplied to the feeding means, where it was introduced into the melt stream of the polyamide component through an injection nozzle. By means of the subsequent mixing line, comprising 15 static mixers of the type SMX with the nominal width DN15 of Sulzer AG, Zu-rich/Switzerland, the additive melt was mixed with the polyamide melt and spun at a temperature of 270° C. at a draw-off speed of 5500 m/min under otherwise identical conditions as in Example 1, where the parameters indicated in Table 1 were achieved with a titer of about 102 dtex over a spooling time of 10 min. The amount of additive added was too low to achieve a significant increase in the elongation at break as compared to the unmodified base polymer from Comparative Example 1, which had been produced at 5500 m/min. Moreover, the threads could not be spooled to thread spools with a commercially relevant weight of the thread spool; after a spooling time of 60 min, the thread spool was again firmly shrunk on the spooling mandrel.

### EXAMPLES 3 AND 4

With an inventive procedure, the PMMA from Example 2 was added to the base polyamide from Example 1 in a concentration of 0.3 and 0.6 wt-%, respectively. The polymer mixtures were spun under otherwise identical conditions as in Example 2, where the textile parameters indicated in Table 1 were achieved.

For both add-on amounts, a significant increase in productivity was achieved as compared to the thread spools produced under the same conditions without adding an additive, and all spooled threads (POY) were characterized by a good processing behavior. For both add-on amounts, the threads could surprisingly be spooled without restriction over commercially relevant spooling times of about 180 min to obtain stable thread spools of 10 kg spool thread weight, which spools could easily be removed from the spooling mandrel. The increase in productivity actually achieved as compared to the conventional process does not result alone from the relative increase in the elongation at break (relative increase of the draft ratio in the subsequent textile process) as compared to the pure polyamide spun at the same speed, but there is opened up a production speed range which has not been accessible so far. The yarn of Example 4, which was produced at a draw-off speed of 5500 m/min and an addition of 0.6 wt-% additive, approximately has the same elongation at break as a yarn spun conventionally without additive polymer at 4500 m/min. With the procedure of Example 4 an increase in productivity of about 22% is thus achieved as compared to the conventional process.

### EXAMPLE 5

A polystyrene (PS) (commercial type Vertyron 136 of Hüls AG, Marl/Germany) was added to the base polymer from Example 1 in a concentration of 0.75 wt-%. The melt viscosity of PS was 280 Pas (2.4 Hz; 270° C.), i.e. the viscosity ratio was 3.5:1. The flow activation energy of PS was 106 kJ/mol, and the glass transition temperature was 106° C. The polymer mixture was spun under otherwise identical conditions as in Example 2, and the textile parameters indicated in Table 1 were achieved. The thread spool could again easily be removed from the winding mandrel after a spooling time of about 180 min with a thread weight of 10 kg and could be processed as POY.

### EXAMPLES 6 TO 8

In these applications of the invention, a polymaleinimide (PMI) (laboratory product of Röhm GmbH, Darmstadt/Germany), i.e. an additive polymer of type e), was added to the base polyamide from Example 1 in the concentrations indicated in Table 1. The PMI was a copolymer with 8.8 wt-% styrene, 86.2 wt-% methyl methacrylate and 5 wt-% N-cyclohexyl maleinimide with a melt viscosity of 600 Pas (2.4 Hz; 270° C.), a viscosity ratio of 7.5:1, a flow activation energy of 120 kJ/mol and a glass transition temperature of 121° C. The polymer mixtures were spun at draw-off speeds of 5500 m/min (Examples 6 and 7) and 6000 m/min (Example 8), where the textile parameters indicated in Table 1 were achieved. At a speed of 6000 m/min the extrusion speed was 41.45 m/min and the draft ratio was 1:145. Examples 6 and 7 show that the PMI, which has a particularly favorable viscosity ratio, has a particularly high specific activity and with a comparatively low addition already has a high increase in elongation at break and a good spooling behavior. The thread spool could again easily be removed from the winding mandrel after a spooling time of 180 min with a thread weight of 10 kg and be processed as POY with good processing properties. In Example 8, a thread spool with a thread weight of 5.4 kg was produced over a spooling time of 90 min, which thread spool could easily be removed from the winding mandrel.

### EXAMPLES 9 AND 10

For these comparative examples, two galette pairs arranged as duo were used in the draw-off system of Example 1 instead of the two galettes arranged in an S-shaped manner. Enlaced 6 times, the bundled thread was drawn off by the first pair of draw-off galettes (duo 1) with a draw-off speed of 4500 m/min, and by means of a second pair of galettes enlaced 10 times (duo 2), which had been heated to a temperature of 180° C., was drafted with two different draft ratios and finally spooled. The draw-off speed and the speed of the second duo are indicated in Table 2 together with the parameters of the threads. The spooling speed was adjusted about 1% lower than the speed of the second duo, so that the thread tension before the spooler was 7 g. The polymer throughput was each adjusted such that the spooled thread had a titer of 77 dtex. The extrusion speed lay in the range between 30 and 33 m/min, the draft ratio between 1:143 and 1:153. After the second galette duo, yarn defects (capillary breakages) on the running thread were recorded by means of a sensor with camera and detected by visual analysis of the pictures. After a spooling time of 80 min, the thread spools could no longer be removed from the winding mandrel at both draw-off speeds.

Furthermore, the threads without addition of additive polymer had defects which exclude a further processing.

### EXAMPLES 11 TO 13

The PMMA of Example 2 was added to the base polyamide by means of the metering and mixing means described there. The additive concentrations, draw-off speeds and the speed of the second galette duo are indicated in Table 2 together with the parameters of the threads. The polymer throughput was again each adjusted such that the spooled thread had a titer of 77 dtex. With a thread tension before the spooler of 7 g, thread spools were produced over a spooling time of 100 min with a thread weight each of more than 4 kg on the spool. Surprisingly, all spools produced in accordance with the invention could easily be removed from the winding mandrel. Moreover, no yarn defect was measured over the measuring length, so that the threads can excellently be processed.

TABLE 2

| | | | | | | | Yarn | Spool |
|---|---|---|---|---|---|---|---|---|
| | | Additive | zDraw-off | Speed of | Elongation | Breaking | defect | thread |
| | Additive | Content | Speed | duo 2 | at break | strength | [per 350 | weight |
| Example | polymer | [wt-%] | [m/min] | [m/min] | [%] | [cN/tex] | km] | [kg] |
| 9 | — | 0 | 4500 | 5600 | 29 | 50 | 2 | <3.4 |
| 10 | — | 0 | 4500 | 5800 | 27 | 51 | 5 | <3.5 |
| 11 | PMMA | 0.15 | 4500 | 5600 | 34 | 51 | 0 | 4.3 |
| 12 | PMMA | 0.30 | 4500 | 5800 | 33 | 52 | 0 | 4.4 |
| 13 | PMMA | 0.30 | 5000 | 6000 | 39 | 50 | 0 | 4.6 |

1. A process of producing synthetic threads from a polymer mixture which consists of a base polymer and at least one additive polymer, wherein the polymer mixture is pressed through nozzle openings as polymer melt with extrusion speeds (s) in the range from 18 to 160 m/min and the filaments thus formed are cooled, combined to threads, the threads are drawn off and spooled by forming at least one thread spool, characterized in that the base polymer is polyamide (PA), that the content of additive polymer in the polymer mixture is not less than M wt-% and not more than 2.5 wt-%, where M is derived from 0.0001·v−0.4, where v is the draw-off speed of the thread, and v lies in the range from 4500 to 8000 m/min, that the additive polymer is amorphous and virtually insoluble in the polymer melt, where the additive polymer in the spooled thread is present in the base polymer in a fibril structure, and that the ratio s:v lies in the range from 1:50 to 1:250.

2. The process as claimed in claim 1, characterized in that the specific spooling tension, as measured directly before the spooler, is 0.04 to 0.2 g/dtex.

3. The process as claimed in claim 1 or 2, characterized in that upon spooling the thread spool has a weight of the spooled thread of at least 4 kg.

4. The process as claimed in claim 1 or any of the preceding claims, characterized in that the relative increase in elongation (D) in the spooled thread is at least 1.02, where D=a/b
with a=elongation at break of the thread consisting of the polymer mixture, and b=elongation at break of the thread which only consists of the base polymer.

5. The process as claimed in claim 1 or any of the preceding claims, characterized in that the ratio of the melt viscosities of the additive polymer and the base polymer is 1.2:1 to 12:1.

6. The process as claimed in claim 1 or any of the preceding claims, characterized in that the additive polymer is an addition polymerization product of at least one ethylenically unsaturated monomer.

7. The process as claimed in claim 6, characterized in that the additive polymer is a polymer of the following monomer unit: 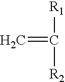
where R₁ and R₂ are substituents consisting of the optional atoms C, H, O, S, P and halogen atoms, and the sum of the molecular weights of R₁ and R₂ is at least 40.

8. The process as claimed in claim 7, characterized in that the additive polymer is a polystyrene.

9. The process as claimed in claim 7, characterized in that the additive polymer is a polymethyl methacrylate.

10. The process as claimed in claim 1 to 6, characterized in that the additive polymer is a copolymer which contains at least one of the monomers acrylic acid, methacrylic acid or CH₂═CR—COOR′, where R is an H atom or CH₃, and R′ is a C₁₋₁₅ alkyl radical or a C₅₋₁₂ cycloalkyl radical or a C₆₋₁₄ aryl radical.

11. The process as claimed in claim 1 or any of the preceding claims, characterized in that a POY thread with an elongation at break of at least 50% is produced, which is spooled without draft, the spooling speed being 1.0 to 0.95 times the draw-off speed.

12. The process as claimed in any of claims 1 to 10, characterized in that there is produced a drafted, smooth thread with an elongation at break of less than 50%, the spooling speed being 1.0 to 1.5 times the draw-off speed.
